(19) United States
(12) Patent Application Publication
(10) Pub. No.: US 2018/0225348 A1
(43) Pub. Date: Aug. 9, 2018

(54) DATABASE PROCESSING METHOD AND DATABASE PROCESSING DEVICE

(71) Applicant: FUJITSU LIMITED, Kawasaki-shi (JP)

(72) Inventor: Wataru Tomiyama, Kobe (JP)

(73) Assignee: FUJITSU LIMITED, Kawasaki-shi (JP)

(21) Appl. No.: 15/889,362

(22) Filed: Feb. 6, 2018

(30) Foreign Application Priority Data
Feb. 9, 2017 (JP) 2017-021810

(51) Int. Cl. G06F 17/30

(52) U.S. Cl. CPC G06F 17/30575; G06F 17/30315

(57) ABSTRACT

A database processing method, executed by a computer, includes: acquiring a plurality of differential logs of a first column-format database, each of the plurality of differential logs indicating a change in the first column-format database with which a second column-format database is to synchronize, determining aggregated logs on the basis of the plurality of differential logs, each of the aggregated logs indicating an aggregated change in a record for a corresponding value of a primary key of the first column-format database, generating at least one change command on the basis of the aggregated logs, the one change command being a command for collectively changing one or more values included in a column of the second column-format database, and applying the at least one change command to the second column-format database.

### CROSS-REFERENCE TO RELATED APPLICATION

This application is based upon and claims the benefit of priority of the prior Japanese Patent Application No. 2017-21810, filed on Feb. 9, 2017, the entire contents of which are incorporated herein by reference.

### FIELD

The embodiment discussed herein is related to a database.

### BACKGROUND

For example, a provider (hereinafter merely referred to as provider) that provides services to users builds and operates a business system (hereinafter also referred to as information processing system) based on the use in order to provide the various services to the users. Specifically, the provider builds the business system including, as configurations, a database storing data items to be used to provide the services, for example.

The aforementioned database includes a row-oriented database (hereinafter also referred to as row-format database) and a column-oriented database (hereinafter also referred to as column-format database) in general. The row-oriented database is a database that is used to manage data items for each of records included in the database and in which a data item is changed for each of the records at higher speed than the column-oriented database (for example, the change is executed to insert a new record into the database, delete a stored record from the database, or the like). The column-oriented database is a database that is used to manage data items for each of data items corresponding to columns included in the database and in which a data item is referenced for each of the columns included in the database at higher speed than the row-oriented database.

Thus, if it is estimated that a data item is frequently changed for each record for the provision of the services, the provider builds a business system including a row-oriented database as a configuration, for example. In addition, if it is estimated that a data item is frequently referenced for each of the columns included in the database for the provision of the services, the provider builds a business system including a column-oriented database as a configuration, for example.

For example, related-art techniques are disclosed in Japanese Laid-open Patent Publication No. 2015-064850, International Publication Pamphlet No. WO2013/141308, and Japanese Laid-open Patent Publication No. 2010-165004.

### SUMMARY

According to an aspect of the invention, a database processing method, executed by a computer, includes: acquiring a plurality of differential logs of a first column-format database, each of the plurality of differential logs indicating a change in the first column-format database with which a second column-format database is to synchronize, determining aggregated logs on the basis of the plurality of differential logs, each of the aggregated logs indicating an aggregated change in a record for a corresponding value of a primary key of the first column-format database, generating at least one change command on the basis of the aggregated logs, the one change command being a command for collectively changing one or more values included in a column of the second column-format database, and applying the at least one change command to the second column-format database.

The object and advantages of the invention will be realized and attained by means of the elements and combinations particularly pointed out in the claims.

It is to be understood that both the foregoing general description and the following contented description are exemplary and explanatory and are not restrictive of the invention, as claimed.

### BRIEF DESCRIPTION OF DRAWINGS

FIG. 1 is a diagram illustrating a configuration of an information processing system;

FIG. 2 is a diagram illustrating a hardware configuration of an information processing device;

FIG. 3 is a functional block diagram of the information processing device;

FIG. 4 is a flowchart describing an overview of a differential log application process according to an embodiment;

FIG. 5 is a diagram describing the overview of the differential log application process according to the embodiment;

FIG. 6 is a flowchart describing contents of the differential log application process according to the embodiment;

FIG. 7 is a flowchart describing the contents of the differential log application process according to the embodiment;

FIG. 8 is a flowchart describing the contents of the differential log application process according to the embodiment;

FIG. 9 is a flowchart describing the contents of the differential log application process according to the embodiment;

FIG. 10 is a flowchart describing the contents of the differential log application process according to the embodiment;

FIG. 11 is a flowchart describing the contents of the differential log application process according to the embodiment;

FIG. 12 is a flowchart describing the contents of the differential log application process according to the embodiment;

FIG. 13 is a diagram describing a specific example of differential logs;

FIG. 14 is a diagram describing a specific example of the differential logs having order information added thereto;

FIG. 15 is a diagram describing a specific example of the differential logs in which a sort is executed for each of primary keys;

FIG. 16 is a diagram describing a specific example of aggregated logs;

FIG. 17 is a diagram describing a specific example of records stored in a copy destination database;

FIG. 18 is a diagram describing a specific example of a record stored in the copy destination database;

FIG. 19 is a diagram describing a specific example of records stored in the copy destination database; and

FIG. 20 is a diagram describing requirements for the determination of change commands.

### DESCRIPTION OF EMBODIMENT

In recent years, the amount of data to be handled by a business system in order to provide a service tends to increase. Thus, in the conventional techniques, the execution time of processes may not be suppressed to constraint time or shorter, depending on the amount of data to be handled by a business system. Thus, in recent years, for example, even if a business system using a column-oriented database is used, it is requested to reduce a time period for updating data in the column-oriented database.

Configuration of Information Processing System

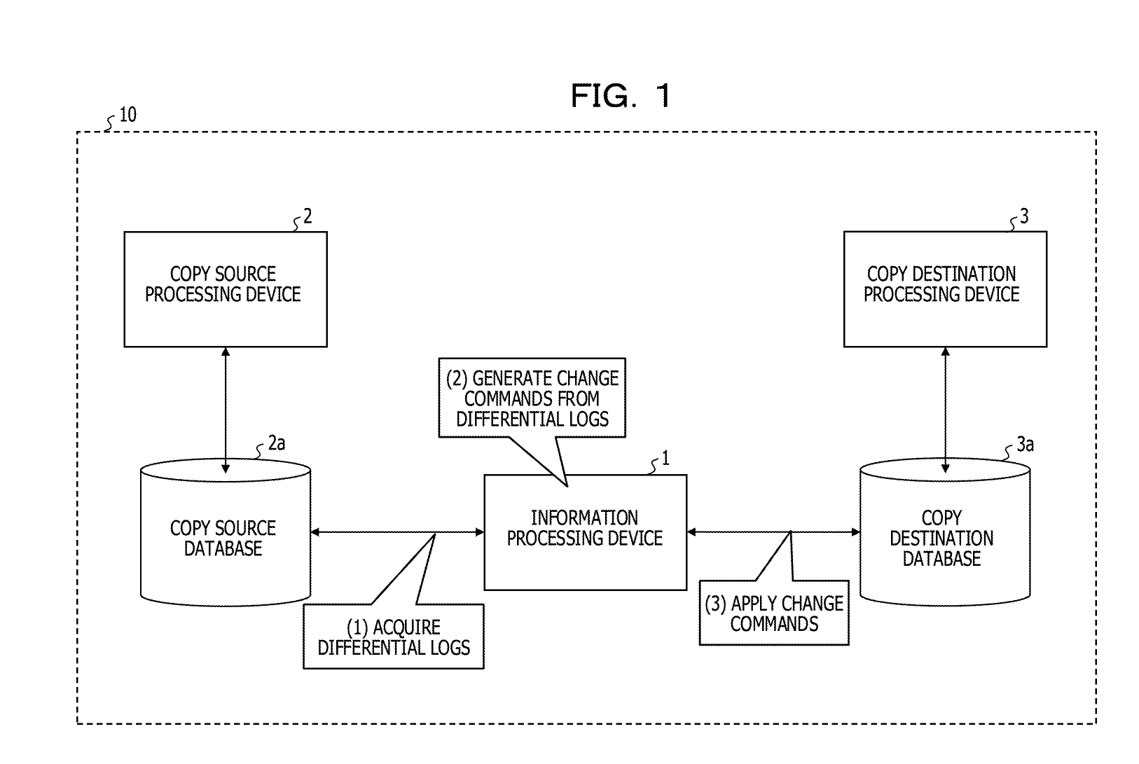

First, a configuration of an information processing system 10 is described. FIG. 1 is a diagram illustrating the configuration of the information processing system 10. The information processing system 10 illustrated in FIG. 1 includes an information processing device 1 (hereinafter also referred to as differential log application device 1), a copy source processing device 2, a copy source storage device 2a (hereinafter also referred to as copy source database 2a), a copy destination processing device 3, and a copy destination storage device 3a (hereinafter also referred to as copy destination database 3a).

The copy source processing device 2 executes a process of enabling a provider to provide services to users, for example. Then, the copy source processing device 2 causes data (records) that are used to provide the services to users to be stored in the copy source database 2a, for example. In addition, the copy source processing device 2 references the data stored in the copy source database 2a, for example.

The copy destination processing device 3 references data stored in the copy destination database 3a and analyzes the data stored in the copy destination database 3a, for example. The copy destination database 3a is described below as a column-oriented database.

Before the data stored in the copy destination database 3a is analyzed, the information processing device 1 synchronizes contents of the data stored in the copy source database 2a with contents of the data stored in the copy destination database 3a. Specifically, the information processing device 1 references the copy source database 2a and acquires logs (hereinafter also referred to as differential logs) indicating contents of data changed between previously executed synchronization and the current time ((1) illustrated in FIG. 1). Then, the information processing device 1 generates, from contents of the acquired differential logs, change commands to change data stored in the copy destination database 3a ((2) illustrated in FIG. 1). After that, the information processing device 1 applies the generated change commands to the data stored in the copy destination database 3a ((3) illustrated in FIG. 1).

The information processing device 1 may synchronize contents of data stored in the copy source database 2a with contents of data stored in the copy destination database 3a within a predetermined time period. Thus, for example, even if the copy destination database 3a is a column-oriented database, the information processing device 1 may apply contents of differential logs to the copy destination database 3a within a short time period.

Thus, the information processing device 1 according to the embodiment generates aggregated logs by aggregating multiple differential logs obtained from the column-oriented database for each of primary keys and generates change commands (hereinafter also referred to as item unit change commands) for items by aggregating the aggregated logs for each of the items of the column-oriented database. Then, the information processing device 1 applies the change commands generated for the items to the column-oriented database. In the embodiment, the items of the column-oriented database correspond to columns of the column-oriented database.

Specifically, the differential logs acquired from the copy source database 2a may indicate that specific records stored in the copy destination database 3a are to be changed multiple times. In this case, the information processing device 1 may not execute the change all the multiple times, and it is sufficient if contents of the specific records are in states after the information processing device 1 executes the last change on the specific records.

Thus, if a record to be changed based on a differential log exists in the copy destination database 3a, the information processing device 1 generates a change command to delete the existing record. Then, the information processing device 1 generates a change command to insert a record indicating contents after the last change executed on the records. After that, the information processing device 1 applies the generated change commands to the copy destination database 3a.

Thus, the information processing device 1 may reduce a time period for updating data for each of records of the column-oriented database.

In addition, for example, if multiple records to be deleted in accordance with change commands exist, the information processing device 1 generates a change command to collectively delete the multiple records and applies the generated change command to the copy destination database 3a. Then, if multiple records to be inserted in accordance with change commands, the information processing device 1 generates an change command to collectively insert the multiple records and applies the generated change command to the copy destination database 3a, for example.

Thus, the information processing device 1 may reduce a time period for updating data for each of records of the column-oriented database.

Hardware Configuration of Information Processing System

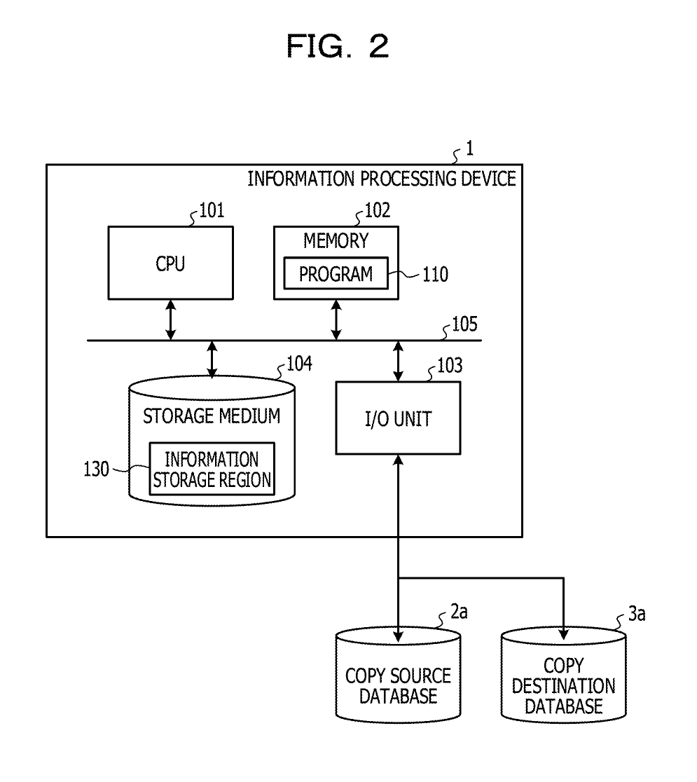

Next, a hardware configuration of the information processing system 10 is described. FIG. 2 is a diagram illustrating a hardware configuration of the information processing device 1.

The information processing device 1 includes a CPU 101, a memory 102, an external interface (input and output (I/O) unit) 103, and a storage medium 104. The CPU 101 is a processor. The units 101 to 104 are connected to each other via a bus 105.

The storage medium 105 stores, in a program storage region (not illustrated) included in the storage medium 105, a program 110 for executing a process (hereinafter also referred to as differential log application process) of applying a differential log to the copy destination database 3a, for example. In addition, the storage medium 104 includes an information storage region 130 (hereinafter also referred to as storage section 130) that stores information to be used in the differential log application process, for example.

The CPU 101 loads the program 110 from the storage medium 104 into the memory 102 and collaborates with the program 110 to execute the differential log application process upon the execution of the program 110. In addition, the external interface 103 communicates with the copy source database 2a and the copy destination database 3a, for example.

Functions of Information Processing System

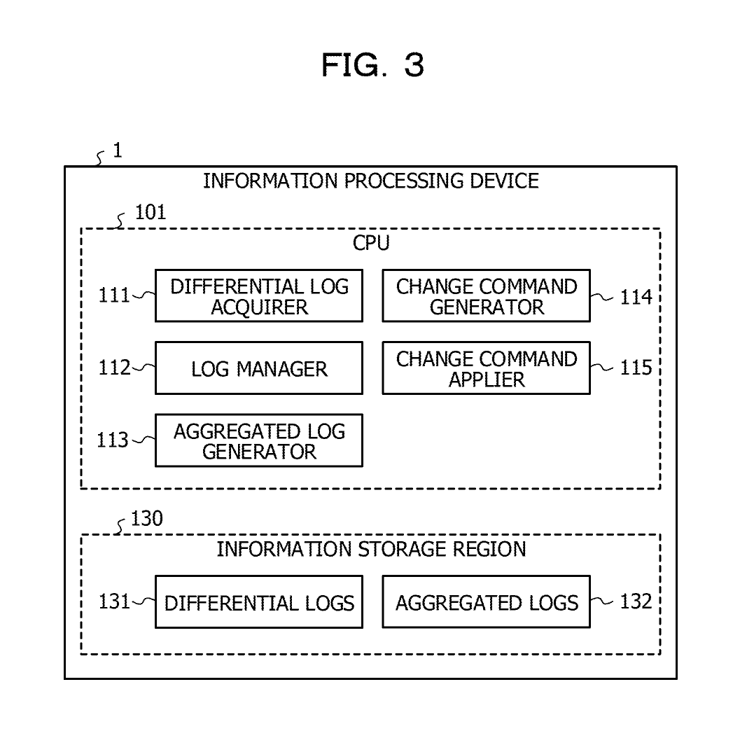

Next, functions of the information processing system 10 are described. FIG. 3 is a functional block diagram of the information processing device 1.

The CPU 101 of the information processing device 1 collaborates with the program 110, thereby operating as a differential log acquirer 111, a log manager 112, an aggregated log generator 113, an change command generator 114, and an change command applier 115. In the information storage region 130, differential logs 131 and aggregated logs 132 are stored, for example. The information storage region 130 may be a database.

The differential log acquirer 111 periodically acquires differential logs 131 from the copy source database 2a. Specifically, if data stored in the copy destination database 3a is analyzed once a day, the differential log acquirer 111 may acquire differential logs 131 from the copy source database 2a once a day. Then, the log manager 112 causes the differential logs 131 acquired by the differential log acquirer 111 to be stored in the information storage region 130.

The aggregated log generator 113 generates aggregated logs 132 by aggregating the differential logs 131 stored in the information storage region 130 for each of primary keys. Then, the log manager 112 causes the aggregated logs 132 generated by the aggregated log generator 113 to be stored in the information storage region 130, for example.

The change command generator 114 generates change commands for the items by aggregating the aggregated logs 132 generated by the aggregated log generator 113 for each of the items of the copy destination database 3a. The change command generator 114 generates the change commands using SQL statements, for example. Then, the change command applier 115 applies the change commands generated for the items by the change command generator 114 to the copy destination database 3a.

### Overview of Embodiment

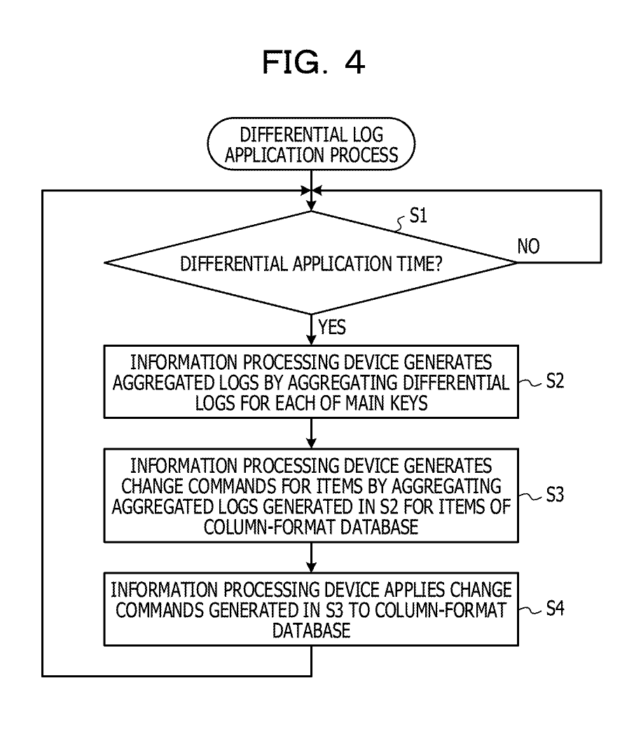

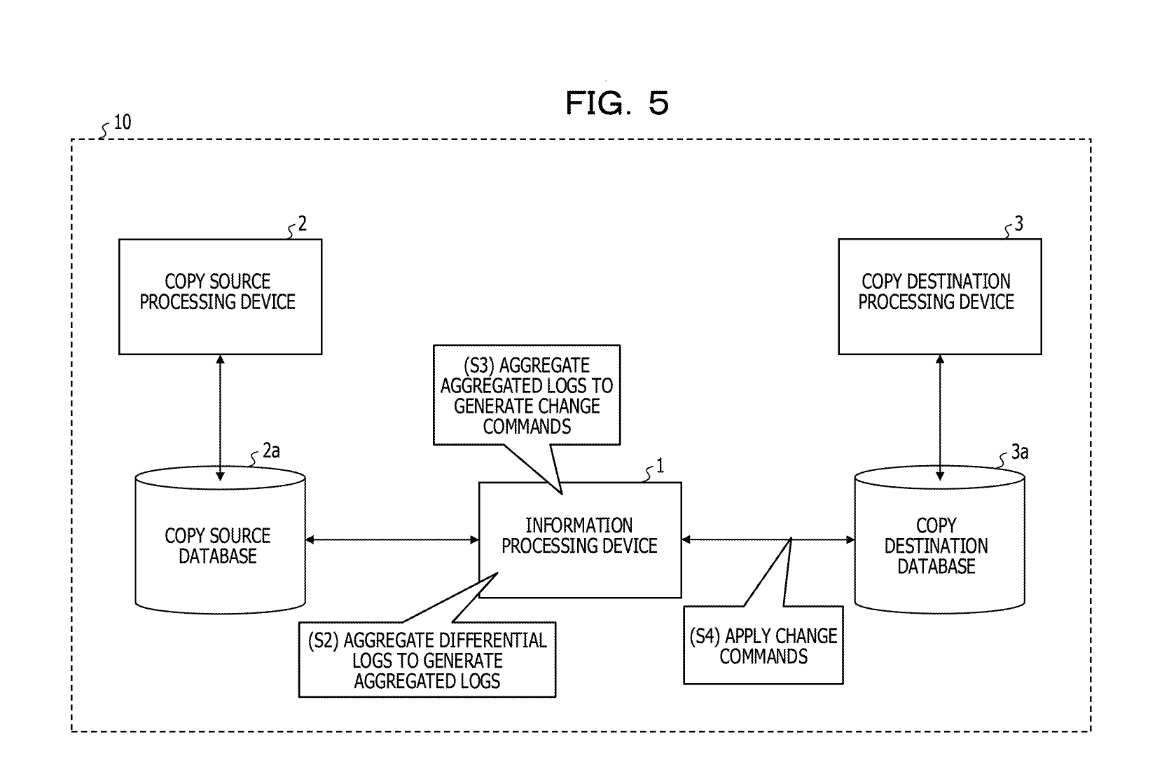

Next, an overview of the embodiment is described. FIG. 4 is a flowchart describing an overview of the differential log application process according to the embodiment. FIG. 5 is a diagram describing the overview of the differential log application process according to the embodiment.

The information processing device 1 stands by until differential application time (NO in S1), as illustrated in FIG. 4. The differential application time is when contents of data stored in the copy source database 2a are synchronized with contents of data stored in the copy destination database 3a. Then, when the current time reaches the differential application time (YES in S1), the information processing device 1 generates aggregated logs 132 by aggregating differential logs 131 for each of primary keys (in S2), as illustrated in FIG. 5.

In addition, the information processing device 1 generates change commands for the items by aggregating the aggregated logs 132 generated in the process S2 for each of the items of the copy destination database 3a (column-oriented database) (in S3). After that, the information processing device 1 applies the change commands generated in the process S3 to the copy destination database 3a (in S4).

Specifically, the differential logs 131 acquired from the copy source database 2a may indicate that specific records stored in the copy destination database 3a are changed multiple times. In this case, the information processing device 1 may not execute the change all the multiple times, and it is sufficient if contents of the specific records are in states after the information processing device 1 execute the last change on the specific records.

Thus, if a record to be changed based on a differential log exists in the copy destination database 3a, the information processing device 1 generates a change command to delete the existing record. Then, the information processing device 1 generates a change command to insert a record indicating contents after the last change executed on the records. After that, the information processing device 1 applies the generated change commands to the copy destination database 3a.

Thus, the information processing device 1 may reduce a time period for updating data for each of records of the column-oriented database.

In addition, for example, if multiple records to be deleted in accordance with change commands exist, the information processing device 1 generates a change command to collectively delete the multiple records and applies the generated change command to the copy destination database 3a. Then, if multiple records are to be inserted in accordance with change commands, the information processing device 1 generates a change command to collectively insert the multiple records and applies the generated change command to the copy destination database 3a.

Thus, if multiple records to be deleted in accordance with change commands exist, the information processing device 1 may suppress the number of times when a change command to delete the records is applied to 1. In addition, even if multiple records to be inserted in accordance with change commands exist, the information processing device 1 may suppress the number of times when a change command to insert the records is applied to 1. Thus, the information processing device 1 may reduce a time period for updating data for each of records of the column-oriented database.

### Contents of Embodiment

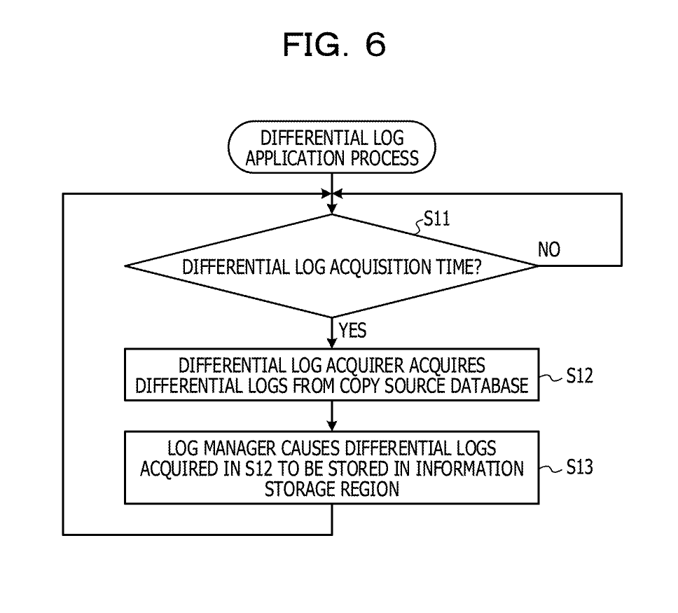

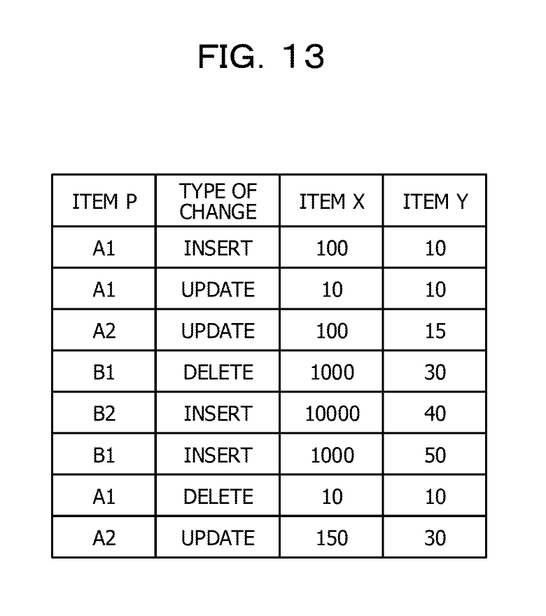

Next, contents of the embodiment are described. FIGS. 6 to 12 are flowcharts describing contents of the differential log application process according to the embodiment. In addition, FIGS. 13 to 20 are diagrams describing the contents of the differential log application process according to the embodiment. The contents of the differential log application process illustrated in FIGS. 6 to 12 are described with reference to FIGS. 13 to 20.

First, a process of extracting differential logs 131 from the copy source database 2a in a differential log extraction process is described below.

The differential log acquirer 111 of the information processing device 1 stands by until differential log acquisition time (NO in S11). The differential log acquisition time is before contents of data stored in the copy source database 2a are synchronized with contents of data stored in the copy destination database 3a, for example. Specifically, the differential log acquisition time is determined by the provider in advance.

Then, when the current time reaches the differential log acquisition time (YES in S11), the differential log acquirer 111 acquires differential logs 131 from the copy source database 2a (in S12). Then, the log manager 112 of the information processing device 1 causes the differential logs 131 acquired in the process S12 to be stored in the information storage region 130 (in S13). A specific example of the differential logs 131 is described below.

Specific Example of Differential Logs

FIG. 13 is a diagram describing the specific example of the differential logs 131. Each of the differential logs 131 illustrated in FIG. 13 includes, items, an “item P” indicating an item serving as a primary key identifying a record included in the copy destination database 3a and including data to be changed, and a “type of change” item indicating a content of the change of data. In each cell included in the “type of change” item, “INSERT” indicating the insertion of a new record, “UPDATE” indicating a update in a content of a stored record, or “DELETE” indicating the deletion of a stored record is set.

In addition, each of the differential logs 131 illustrated in FIG. 13 includes, as items, an “item X” and an “item Y” that indicate items corresponding to data included in the records. If “DELETE” is set in the “type of change” item, contents of a record to be deleted are set in the “item X” and the “item Y”. If “INSERT” is set in the “type of change” item, contents of a record to be inserted are set in the “item X” and the “item Y”. If “UPDATE” is set in the “type of change” item, contents of a record that are to be updated are set in the “item X” and the “item Y”.

Specifically, the differential logs 131 illustrated in FIG. 13 include a log within a record in which “A1” is set in the “item P”, “INSERT” is set in the “type of change” item, “100” is set in the “item X”, and “10” is set in the “item Y”, for example. In addition, the differential logs 131 illustrated in FIG. 13 include a log within a record in which “A1” is set in the “item P”, “UPDATE” is set in the “type of change” item, “10” is set in the “item X”, and “10” is set in the “item Y”, for example. A description of other logs included in the differential logs 131 illustrated in FIG. 13 is omitted.

If multiple primary keys of records stored in the copy destination database 3a exist, the differential logs 131 illustrated in FIG. 13 may include the number of “items P” corresponding to the number of combinations of the existing primary keys.

Next, a process of applying change commands corresponding to differential logs 131 to the copy destination database 3a in the differential log extraction process is described.

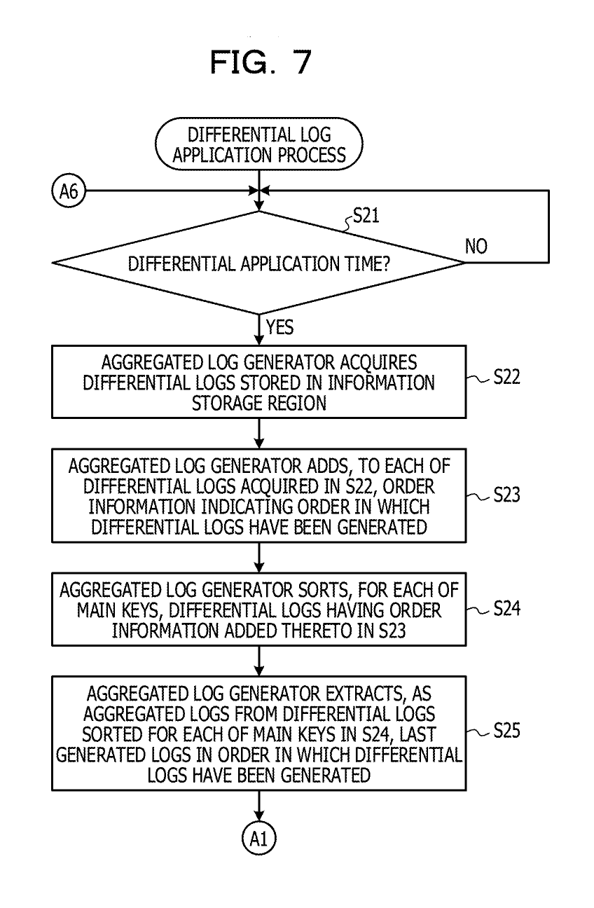

The aggregated log generator 113 of the information processing device 1 stands by until the differential application time (NO in S21), as illustrated in FIG. 7. Then, when the current time reaches the differential application time (YES in S21), the aggregated log generator 113 acquires differential logs 131 stored in the information storage region 130 (in S22).

In addition, the aggregated log generator 113 adds, to each of the differential logs 131 acquired in the process S22, order information indicating the order in which the differential logs 131 have been generated (in S23). Specifically, the aggregated log generator 113 may acquire, from the copy source database 2a, generation time when the differential logs 131 have been generated, and the aggregated log generator 113 may add the order information to the differential logs 131 based on the acquired generation time. In addition, if the generation time when the differential logs 131 have been generated is included in the differential logs 131, the aggregated log generator 113 may add additional information to the differential logs 131 based on the generation time included in the differential logs 131. A specific example of the differential logs 131 having the order information added thereto is described below.

Specific Example of Differential Logs Having Order Information Added Thereto

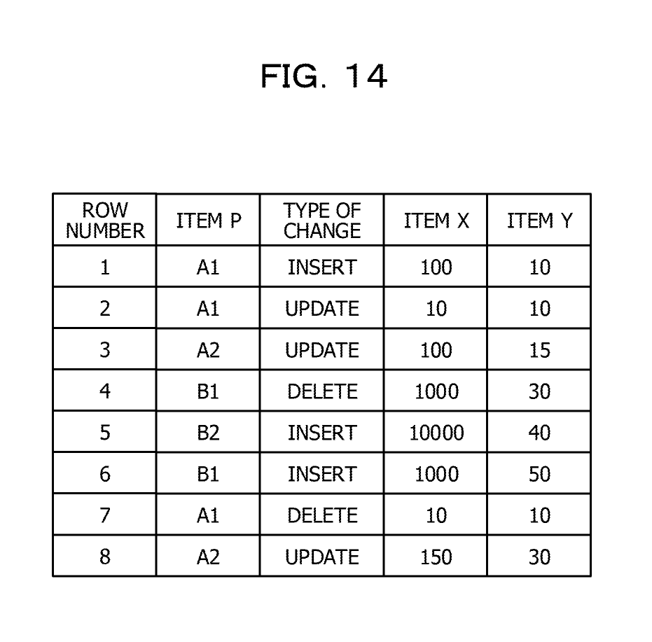

FIG. 14 is a diagram describing the specific example of the differential logs 131 having the order information added thereto. Each of the differential logs 131 illustrated in FIG. 14 includes the items described with reference to FIG. 13 and includes, as an item, a “row number” item indicating the order in which the differential logs 131 have been generated.

Specifically, in the differential logs 131 illustrated in FIG. 14, in a log within a record in which “A1” is set in the “item P” and “INSERT” is set in the “type of change” item, “1” is set in the “row number” item, for example. In addition, in the differential logs 131 illustrated in FIG. 14, in a log within a record in which “A1” is set in the “item P” and “UPDATE” is set in the “type of change” item, “2” is set in the “row number” item, for example. A description of other logs included in the differential log 131 illustrated in FIG. 14 is omitted.

Return to FIG. 7. The aggregated log generator 113 sorts, for each of the primary keys, the differential logs 131 having the order information added thereto in the process S23 (in S24). The differential logs 131 after the sort executed for each of the primary keys are described below.

Specific Example of Differential Logs Sorted for Each of Primary Keys

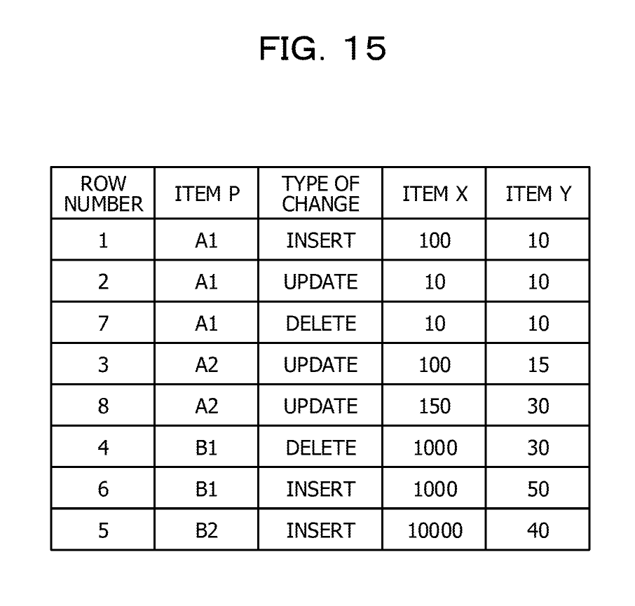

FIG. 15 is a diagram describing the specific example of the differential logs 131 sorted for each of the primary keys. In the “item P” for the differential logs 131 described with reference to FIG. 14, “A1”, “A2”, “B1”, and “B2” are set. Thus, the aggregated log generator 113 classifies the differential logs 131 described with reference to FIG. 14 into the logs in which “A1”, “A2”, “B1”, and “B2” are set in the “item P” and sorts the differential logs 131 in ascending order of number set in the “row number” item.

Specifically, the aggregated log generator 113 identifies, from the differential logs 131 described with reference to FIG. 14, logs in which “A1” is set in the “item P” and in which “1”, “2”, and “7” are set in the “row number” item, for example. Then, the aggregated log generator 113 sorts the identified logs in the order from a log in which “1” is set in the “row number” item, a log in which “2” is set in the “row number” item, and a log in which “7” is set in the “row number” item, as illustrated in FIG. 15. In addition, the aggregated log generator 113 identifies, from the differential logs 131 described with reference to FIG. 14, logs in which “A2” is set in the “item P” and in which “3” and “8” are set in the “row number” item. Then, the aggregated log generator 113 sorts the identified logs in the order of a log in which “3” is set in the “row number” item and a log in which “8” is set in the “row number” item, as illustrated in FIG. 15. A description of other logs included in the differential log 131 illustrated in FIG. 15 is omitted.

Return to FIG. 7. The aggregated log generator 113 extracts (generates) last generated logs as aggregated logs 132 from the differential logs 131 sorted for each of the primary keys in the process S24 (in S25). A specific example of the aggregated logs 132 is described below.

Specific Example of Aggregated Logs

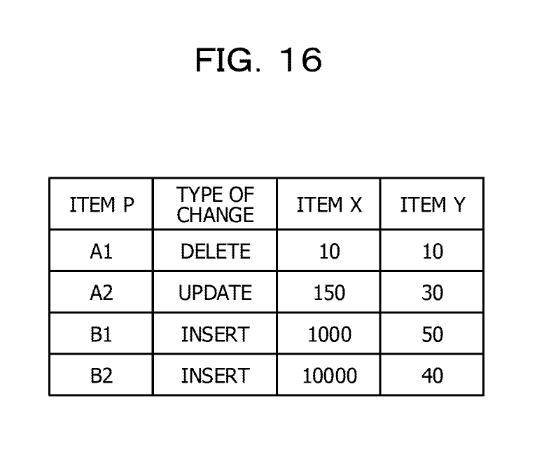

FIG. 16 is a diagram describing the specific example of the aggregated logs 132. Each of the aggregated logs 132 illustrated in FIG. 16 has the same items as those of the differential logs 131 described with reference to FIG. 13.

The aggregated log generator 113 extracts, from each group of logs in which the same information is set in the “item P”, a log in which a number set in the “row number” item is largest in the process S24. Specifically, as illustrated in FIG. 16, the aggregated log generator 113 extracts, as an aggregated log 132 from the logs that are included in the differential logs 131 described with reference to FIG. 15 and in which “A1” is set in the “item P”, the log in which “7” is set in the “row number” item, for example. In addition, as illustrated in FIG. 16, the aggregated log generator 113 extracts, as an aggregated log 132 from logs that are included in the differential logs 131 described with reference to FIG. 15 and in which “A2” is set in the “item P”, the log in which “8” is set in the “row number” item, for example. A description of other logs included in the aggregated logs 132 illustrated in FIG. 16 is omitted.

Specifically, the aggregated log generator 113 generates, from the differential logs 131 acquired from the copy source database 2a, the aggregated logs 132 to be reflected in the copy destination database 3a. Then, the change command generator 114 of the information processing device 1 generates change commands based on the aggregated logs 132, as described later.

Thus, the change command applier 115 of the information processing device 1 may suppress the number of change commands to be applied to the copy destination database 3a, as described later. Thus, the change command applier 115 may reduce a time period for synchronizing contents of data stored in the copy source database 2a with contents of data stored in the copy destination database 3a.

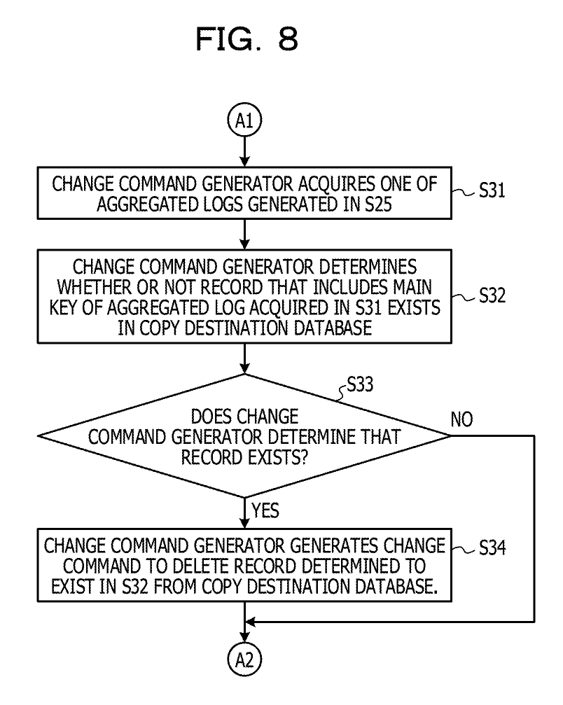

Return to FIG. 8. The change command generator 114 acquires one of the aggregated logs 132 generated in the process S25 (in S31). Specifically, the change command generator 114 acquires, from the aggregated logs 132 described with reference to FIG. 16, the log in which “A1” is set in the “item P”, for example.

Then, the change command generator 114 determines whether or not a record that includes a primary key included in the aggregated log 132 acquired in the process S31 exists in the copy destination database 3a (in S32). A specific example of records stored in the copy destination database 3a is described below.

First Specific Example of Records Stored in Copy Destination Database

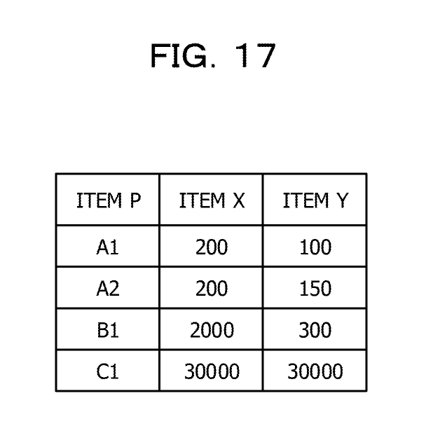

FIGS. 17 to 19 are diagrams describing the specific example of the records stored in the copy destination database 3a. Records illustrated in FIG. 17 and the like include, as items, an “item P”, an “item X”, and an “item Y”.

Specifically, the records illustrated in FIG. 17 include a record in which “A1” is set in the “item P”, “200” is set in the “item X”, and “100” is set in the “item Y”, for example. In addition, the records illustrated in FIG. 17 include a record in which “A2” is set in the “item P”, “200” is set in the “item X”, and “150” is set in the “item Y”, for example. A description of the other records illustrated in FIG. 17 is omitted.

Thus, if the aggregated log 132 acquired in the process S31 is a log in which “A1” is set in the “item P”, the change command generator 114 determines that a record that includes a primary key of the aggregated log 132 acquired in the process S31 exists in the copy destination database 3a.

Return to FIG. 8. If the change command generator 114 determines that the record exists in the process S32 (YES in S33), the change command generator 114 generates a change command to delete, from the copy destination database 3a, the record determined to exist in the process S32 (in S34). Specifically, if the log acquired in the process S31 is a log in which “A1” is set in the “item P”, the change command generator 114 generates a change command to delete, from the records illustrated in FIG. 17, the record in which “A1” is set in the “item P”, for example.

On the other hand, if the change command generator 114 determines that the record does not exist in the process S32 (NO in S33), the change command generator 114 does not execute the process S34. In this case, the change command generator 114 determines that a record to be deleted does not exist in the copy destination database 3a.

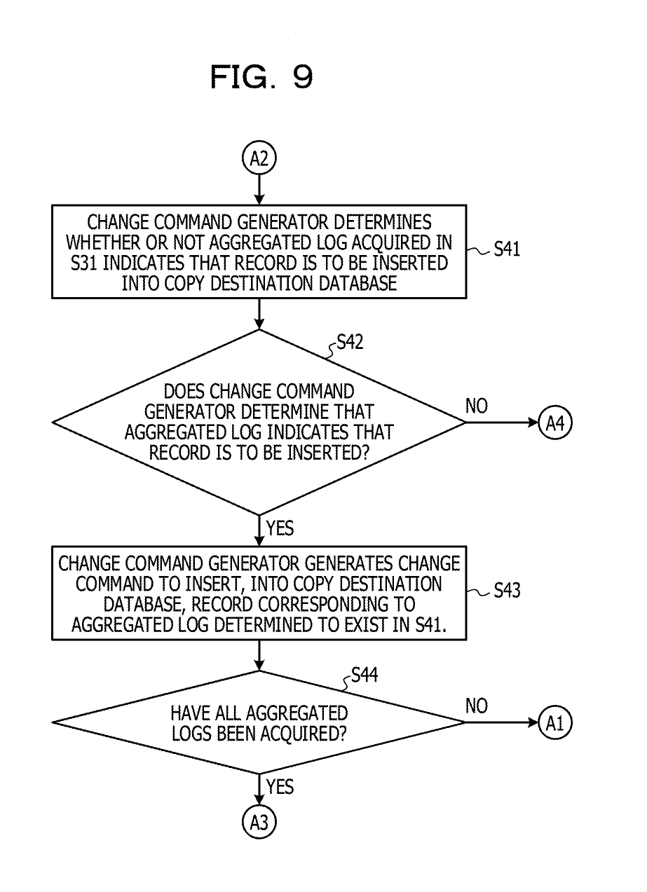

Subsequently, as illustrated in FIG. 9, the change command generator 114 determines whether or not the aggregated log 132 acquired in the process S31 indicates that a record is to be inserted into the copy destination database 3a (in S41).

If the change command generator 114 determines that the aggregated log 132 indicates that the record is to be inserted (YES in S41), the change command generator 114 generates an change command to insert, into the copy destination database 3a, the record corresponding to the aggregated log 132 determined to exist in the process S41 (in S43). If the acquisition of all the aggregated logs 132 generated in the process S25 has not been completed (NO in S44), the change command generator 114 executes the processes S31 and later again.

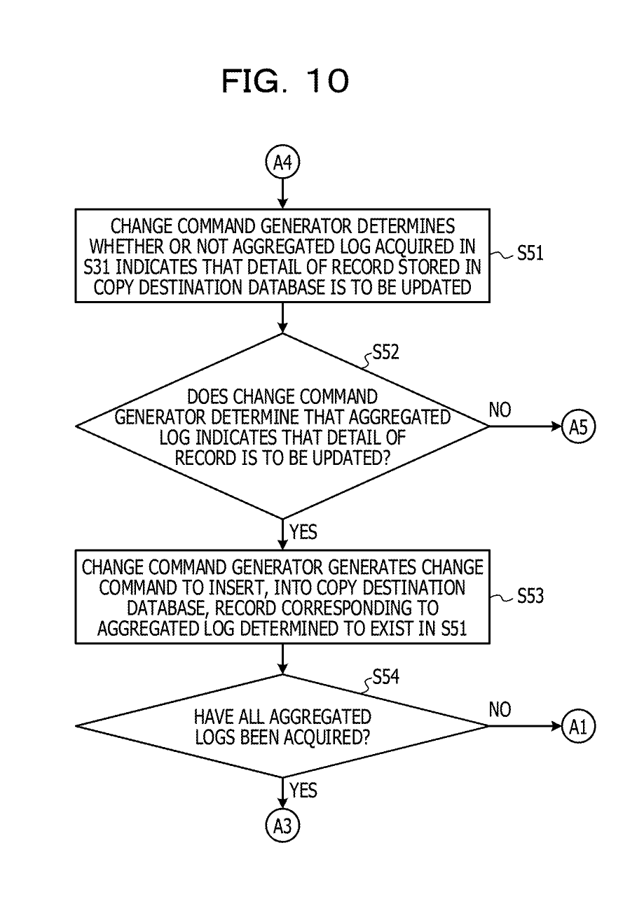

On the other hand, if the change command generator 114 determines that the aggregated log 132 does not indicates that the record is to be inserted (NO in S42), as illustrated in FIG. 10, the change command generator 114 determines whether or not the aggregated log 132 acquired in the process S31 indicates that a content of a record stored in the copy destination database 3a is to be updated (in S51).

If the change command generator 114 determines that the aggregated log 132 indicates that the content of the record is to be updated (YES in S52), the change command generator 114 generates an change command to insert, into the copy destination database 3a, a record corresponding to the aggregated log 132 determined to exist in the process S41 (in S53). Specifically, the change command generator 114 generates the change command to insert, into the copy destination database 3a, the record in a state after the update indicated by the aggregated log 132 acquired in the process S31 is applied. Then, if the acquisition of all the aggregated logs 132 generated in the process S25 has not been completed (NO in S54), the change command generator 114 executes the processes S31 and later again.

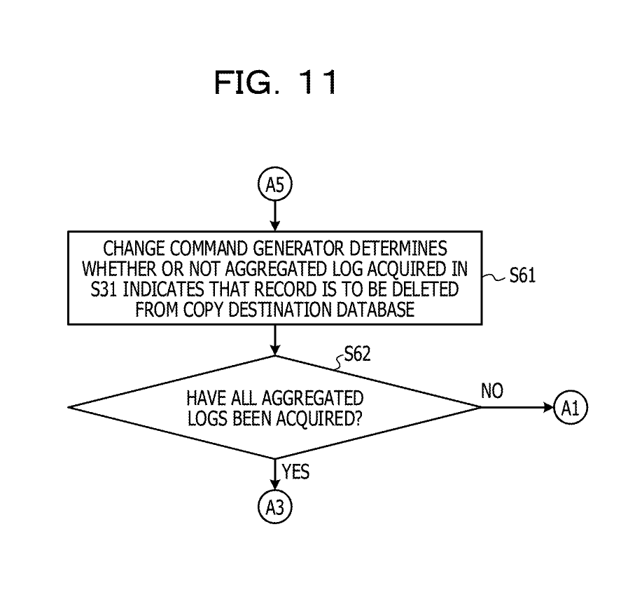

On the other hand, if the change command generator 114 determines that the aggregated log 132 does not indicate that the content of the record is to be updated (NO in S52), the change command generator 114 determines that the aggregated log 132 acquired in the process S31 indicates the deletion of a record from the copy destination database 3a (in S61), as illustrated in FIG. 11. Then, if the acquisition of all the aggregated logs 132 generated in the process S25 has not been completed (NO in S62), the change command generator 114 executes the processes S31 and later again.

Specifically, if the aggregated log 132 acquired in the process S31 does not indicate the insertion of a record and does not indicate a update in a content of a record, the change command generator 114 determines that the aggregated log 132 acquired in the process S31 indicates the deletion of a record. In this case, the change command generator 114 determines that a change command to insert a record is not to be generated.

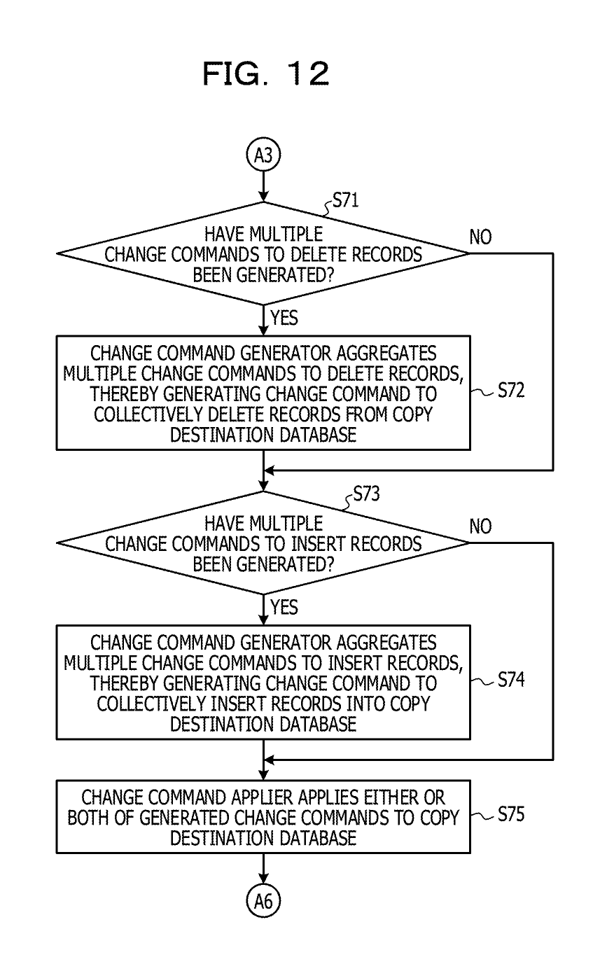

If the acquisition of all the aggregated logs 132 generated in the process S25 has been completed (YES in S44, S54, and S62), the change command generator 114 determines whether or not multiple change commands to delete records have been generated in the process S34 (in S72), as illustrated in FIG. 12.

If the change command generator 114 determines that the multiple change commands to delete the records have been generated (YES in S71), the change command generator 114 aggregates the multiple change commands to delete the records, thereby generating an change command to collectively delete the records from the copy destination database 3a (in S72). On the other hand, if only a single change command to delete a record has been generated in the process S34 (NO in S71), the change command generator 114 does not execute the process S72.

Specifically, if multiple records to be deleted from the copy destination database 3a exist, the change command generator 114 generates a change command to collectively delete the multiple records. Thus, the change command generator 114 may reduce a time period for synchronizing contents of data stored in the copy source database 2a with contents of data stored in the copy destination database 3a.

In addition, the change command generator 114 determines whether or not multiple change commands to insert records have been generated in the process S43 or the process S53 (in S73). If the change command generator 114 determines that the multiple change commands to insert the records have been generated (YES in S73), the change command generator 114 aggregates the multiple change commands to insert the records, thereby generating an change command to collectively insert the records into the copy destination database 3a (in S74). On the other hand, if only a single change command to insert a record has been generated in the process S43 or the process S53 or if a change command to insert a record has not been generated in the process S43 or the process S53, the change command generator 114 does not execute the process S74.

Specifically, if multiple records to be inserted into the copy destination database 3a exist, the change command generator 114 generates a change command to collectively insert the multiple records. Thus, the change command generator 114 may reduce a time period for synchronizing contents of data stored in the copy source database 2a with contents of data stored in the copy destination database 3a, like the case where the process S72 is executed.

Then, the change command applier 115 applies either or both of the change command generated in the processes S72 and the change command generated in the processes S74 to the copy destination database 3a (in S75). After that, the aggregated log generator 113 stands by until the next differential application time (in S21).

If multiple change commands to delete records and multiple change commands to insert records have been generated, these change commands are aggregated in the processes S72 and S74. It is, therefore, sufficient if the change command applier 115 applies a change command to delete the records to the copy destination database 3a up to one time and applies a change command to insert the records into the copy destination database 3a up to one time. A specific example of records stored in the copy destination database 3a after a change command to delete a record is applied is described below.

Second Specific Example of Records Stored in Copy Destination Database

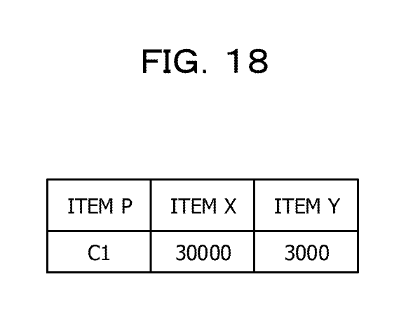

FIG. 18 is a diagram describing the specific example of the records stored in the copy destination database 3a after the change command to delete the record is applied.

Logs that are among the aggregated logs 132 described with reference to FIG. 16 and include information that is set in the “item P” and is the same as information included in the records described with reference to FIG. 17 are logs in which “A1”, “A2”, and “B1” are set in the “item P”. Thus, the change command generator 114 generates a change command to delete records in which “A1”, “A2”, and “B1” are set in the “item P” in the process S34. Then, the change command generator 114 generates a change command to collectively delete the records in which “A1”, “A2”, and “B1” are set in the “item P” in the process S72.

After that, the change command applier 115 applies the change command generated in the process S34 (and the change command generated in the process S72) to the copy destination database 3a and deletes, from the records illustrated in FIG. 17, the records in which “A1”, “A2”, and “B1” are set in the “item P”, as illustrated in FIG. 18. A specific example of records stored in the copy destination database 3a after a change command to insert a record is applied is described below.

Third Specific Example of Records Stored in Copy Destination Database

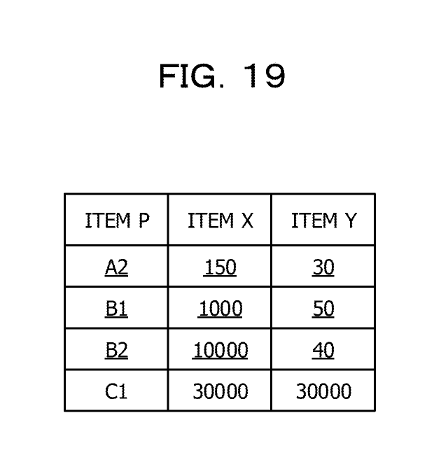

FIG. 19 is a diagram describing the specific example of the records stored in the copy destination database 3a after the change command to insert the record is applied.

A log that is among the aggregated logs 132 described with reference to FIG. 16 and in which “UPDATE” is set in the “type of change” item is a log in which “A2” is set in the “item P”. In addition, logs that are among the aggregated logs 132 described with reference to FIG. 16 and in which “INSERT” is set in the “type of change” item are logs in which “B1” and “B2” are set in the “item P”. Thus, in the process S43, the change command generator 114 generates a change command to insert a record in which “A2” is set in the “item P”. In addition, in the process S53, the change command generator 114 generates a change command to insert records in which “B1” and “B2” are set in the “item P”. Then, in the process S74, the change command generator 114 generates a change command to collectively insert the records in which “B1” and “B2” are set in the “item P”.

After that, the change command applier 115 applies the change command generated in the process S43 or the change command generated in the process S53 (and the change command generated in the process S74) to the copy destination database 3a and add, to the record illustrated in FIG. 18, the records that are among records corresponding to the aggregated logs 132 described with reference to FIG. 16 and in which “A2”, “B1”, and “B2” are set in the “item P”.

Requirements for Determination of Change Commands

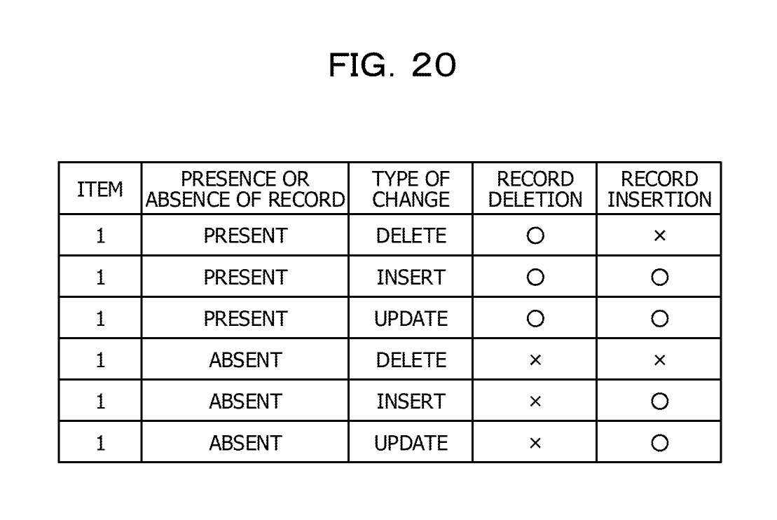

Next, requirements for the determination of change commands are described. FIG. 20 is a diagram describing the requirements for the determination of change commands. Contents illustrated in FIG. 20 correspond to the contents described with reference to FIGS. 7 to 12.

The contents illustrated in FIG. 20 include, as items, an “item number” item identifying the requirements and a “presence or absence of record” item indicating whether or not the records identified by the information set in the “item P” of the aggregated logs 132 illustrated in FIG. 16 have been stored in the copy destination database 3a. In each cell included in the “presence or absence of record” item, “present” indicating that a record has been stored in the copy destination database 3a or “absent” indicating that a record has not been stored in the copy destination database 3a is set. In addition, the contents illustrated in FIG. 20 include, as items, a “type of change” item in which information set in the “type of change” item of the aggregated logs 132 described with reference to FIG. 16 is set, a “record deletion” item indicating whether or not an change command to delete a record is to be generated, and a “record insertion” item indicating whether or not an change command to insert a record is to be generated. In each cell included in the “record deletion” item and each cell included in the “record insertion” item, “◯” indicating that an change command is to be generated or “x” indicating that an change command is not to be generated is set.

Specifically, in FIG. 20, in information (information in which “1”, “2”, and “3” are set in the “item number” item) in which “present” is set in the “presence or absence of record” item, “◯” is set in the “record deletion” item. Specifically, the information in which “1”, “2”, and “3” are set in the “item number” item indicates that, if a record identified by information set in the “item P” of an aggregated log 132 has been stored in the copy destination database 3a, an change command to delete the record is generated (YES in S33, S34).

In FIG. 20, in information (information in which “4”, “5”, and “6” are set in the “item number” item) in which “absent” is set in the “presence or absence of record” item, “x” is set in the “record deletion” item. Specifically, in FIG. 20, the information in which “4”, “5”, and “6” are set in the “item number” item indicates that, if a record identified by information set in the “item P” of an aggregated log 132 has not been stored in the copy destination database 3a, an change command to delete the record is not generated (NO in S33).

In addition, in FIG. 20, in information (“2”, “3”, “5”, and “6” are set in the “item number” item) in which “INSERT” or “UPDATE” is set in the “type of change” item, “◯” is set in the “record insertion” item. Specifically, the information in which “2”, “3”, “5”, and “6” are set in the “item number” item indicates that, if an aggregated log 132 indicates that a record is to be inserted or that a content of a record is to be updated, an change command to insert the record is generated (YES in S42, S43, YES in S52, S53).

In FIG. 20, in information (“1” and “4” are set in the “item number” item) in which “DELETE” is set in the “type of change” item, “x” is set in the “record insertion” item. Specifically, in FIG. 20, the information in which “1” and “4” are set in the “item number” item indicates that, if an aggregated log 132 indicates the deletion of a record, an change command to insert the record is not generated (NO in S42, NO in S52).

In this manner, the information processing device 1 according to the embodiment generates aggregated logs 132 by aggregating differential logs 131 for each of primary keys and generates change commands for the items by aggregating the aggregated logs 132 for the items of the copy destination database 3a. Then, the information processing device 1 applies the change commands generated for the items to the copy destination database 3a.

Specifically, the differential logs 131 acquired from the copy source database 2a may indicate that specific records stored in the copy destination database 3a are to be changed multiple times. In this case, the information processing device 1 may not change the specific records all the multiple times, and it is sufficient if contents of the specific records are in states after the information processing device 1 executes the last change on the specific records.

Thus, if a record to be changed based on a differential log exists in the copy destination database 3a, the information processing device 1 generates a change command to delete the existing record. Then, the information processing device 1 generates a change command to insert a record indicating contents after the last change executed on the records. After that, the information processing device 1 applies the generated change commands to the copy destination database 3a.

Thus, the information processing device 1 may reduce a time period for updating data for each of records of the column-oriented database.

In addition, for example, if multiple records to be deleted in accordance with change commands exist, the information processing device 1 generates a change command to collectively delete the multiple records and applies the generated change command to the copy destination database 3a. For example, if multiple records to be inserted in accordance with change commands, the information processing device 1 generates a change command to collectively insert the multiple records and applies the generated change command to the copy destination database 3a.

Thus, the information processing device 1 may reduce a time period for updating data for each of records of the column-oriented database.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in content, it should be understood that the various updates, substitutions, and alterations could be made hereto without departing from the spirit and scope of the invention.

What is claimed is:

1. A database processing method executed by a computer, the method comprising:
acquiring a plurality of differential logs of a first column-format database, each of the plurality of differential logs indicating a change in the first column-format database with which a second column-format database is to synchronize;
determining aggregated logs on the basis of the plurality of differential logs, each of the aggregated logs indicating an aggregated change in a record for a corresponding value of a primary key of the first column-format database;
generating at least one change command on the basis of the aggregated logs, the one change command being a command for collectively changing one or more values included in a column of the second column-format database; and
applying the at least one change command to the second column-format database.

2. The database processing method according to claim 1, wherein the aggregated logs are determined based on an order in which the plurality of differential logs have been generated.

3. The database processing method according to claim 1, wherein the plurality of differential logs have order information added thereto and indicating an order in which the plurality of differential logs have been generated.

4. The database processing method according to claim 3, wherein the aggregated log related to a first corresponding value of the primary key corresponds to a last generated log in an order in which the differential logs related to the first corresponding value of the primary key have been generated.

5. The database processing method according to claim 1, wherein the at least one change command is generated based on whether or not a record including a first corresponding value of the primary key exists in the second column-format database.

6. The database processing method according to claim 5, wherein when a aggregated log indicates that a record including the first corresponding value of the primary key has been inserted into the first column-format database, and a record including the first corresponding value of the primary key does not exist in the second column-format database, the at least one change command includes an change command to insert a record corresponding to the aggregated log into the second column-format database.

7. The database processing method according to claim 5, wherein when a aggregated log indicates that a record including the first corresponding value of the primary key has been inserted into the first column-format database, and a record including the first corresponding value of the primary key exists in the second column-format database, the at least change command includes an change command to delete the record including the first corresponding value of the primary key from the second column-format database and another change command to insert a record corresponding to the aggregated log into the second column-format database.

8. The database processing method according to claim 5, wherein when a aggregated log indicates that a content of a record including the first corresponding value of the primary key has been updated in the first column-format database, and a record including the first corresponding value of the primary key does not exist in the second column-format database, the at least one change command includes an change command to insert a record corresponding to the aggregated log into the second column-format database.

9. The database processing method according to claim 5, wherein when a aggregated log indicates that a content of a record including the first corresponding value of the primary key has been updated in the first column-format database, and a record including the first corresponding value of the primary key exists in the second column-format database, the at least one change command includes a change command to delete the record including the first corresponding value of the primary key from the second column-format database and another change command to insert a record corresponding to the aggregated log into the second column-format database.

10. The database processing method according to claim 5, wherein when a aggregated log indicates that a record including the first corresponding value of the primary key has been deleted from the first column-format database, and a record including the first corresponding value of the primary key exists in the second column-format database, the at least one change command includes a change command to delete the record including the first corresponding value of the primary key from the second column-format database.

11. The database processing method according to claim 1, wherein when a aggregated log indicates that a record including a first corresponding value of the primary key has been deleted from the first column-format database, and another aggregated log indicates that a record including a second corresponding value of the primary key has been deleted from the first column-format database, the at least change command include a change command to collectively delete, from the second column-format database, a record including the first corresponding value of the primary key and a record including the second corresponding value of the primary key.

12. The database processing method according to claim 1, wherein when a aggregated log indicates that a record related to a first primary key is to be inserted into the column-format database, and another aggregated log indicates that a record related to a second primary key is to be inserted into the column-format database, the change commands include an change command to collectively insert, into the column-format database, the record related to the first primary key and the record related to the second primary key.

13. The database processing method according to claim 1, wherein the second column-format database stores data in association with each other for each of the columns.

14. A database processing device comprising:
a memory; and
a processor coupled to the memory and the processor configured to:
acquire a plurality of differential logs of a first column-format database, each of the plurality of differential logs indicating a change in the first column-format database with which a second column-format database is to synchronize,
determine aggregated logs on the basis of the plurality of differential logs, each of the aggregated logs indicating an aggregated change in a record for a corresponding value of a primary key of the first column-format database,
generate at least one change command on the basis of the aggregated logs, the one change command being a command for collectively changing one or more values included in a column of the second column-format database, and
apply the at least one change command to the second column-format database.

15. A non-transitory computer-readable medium storing a database processing program that causes a computer to execute a process comprising:
acquiring a plurality of differential logs of a first column-format database, each of the plurality of differential logs indicating a change in the first column-format database with which a second column-format database is to synchronize;
determining aggregated logs on the basis of the plurality of differential logs, each of the aggregated logs indicating an aggregated change in a record for a corresponding value of a primary key of the first column-format database;
generating at least one change command on the basis of the aggregated logs, the one change command being a command for collectively changing one or more values included in a column of the second column-format database; and
applying the at least one change command to the second column-format database.
